(19) United States
(12) Patent Application Publication
(10) Pub. No.: US 2004/0210416 A1
(43) Pub. Date: Oct. 21, 2004

(54) Measuring system for processing angular and linear measured values

(76) Inventor: Anton Rodi, Leimen (DE)

Correspondence Address: LERNER AND GREENBERG, PA, P O BOX 2480, HOLLYWOOD, FL, 33022-2480, US

(21) Appl. No.: 10/819,324

(22) Filed: Apr. 6, 2004

(30) Foreign Application Priority Data
Apr. 16, 2003 (DE) 103 17 803.1

(51) Int. Cl. G01B 5/02

(52) U.S. Cl. 702/163

(57) ABSTRACT

An angular and linear measuring system processes measured values. The absolute values created in an encoder are permanently transferred via a serial data output to a receiver unit not belonging to the encoder where the absolute values are temporarily stored and then outputted to a controller. This has the advantage of providing rapid data transfer from the encoder to the controller.

### BACKGROUND OF THE INVENTION

### FILED OF THE INVENTION

Absolute angular and linear measuring systems are increasingly replacing the current incremental encoder configurations that use for example A/B or sin/cos signals shifted by 90°. For high resolutions in particular it makes sense to produce absolute values via serial data transfer, since this reduces semiconductor connections together with the number of cables and plugs and can be produced as a cost-effective configuration. The desire for greater resolutions of angular and linear segments and increasing processing speed of adjustment units on industrial apparatus, machines and equipment makes great demands on the processing of measured signals and the transfer of measured data.

In addition, automation technology is leading to increased use of distributed controllers with a plurality of sensors and actuators whose IT connection via complex bus systems is increasingly required to be undertaken during the production process.

We make particular reference to, for example, Published European Patent Application EP 110 203 A1 or my earlier Published, Non-Prosecuted German Patent Application DE 101 23 292 A1, corresponding to U.S. Pat. No. 6,667,696, that describe high resolution absolute angular and linear measuring systems. The measuring systems described therein guarantee fast data transfer, e.g. via the SSI interface. In addition, measured data can be requested by the controller at defined times with virtually no time delay within the measurement time of several tens of nsec and transferred via clock frequencies. This also allows the master controller to make requests of several encoders at the same time and the measured values allow synchronization of e.g. multi-axis drives within the measurement time with a maximum “jitter” of several tens of nsec. Attempts to use bus systems for requests and synchronization at specific points fail due to top heavy transfer protocols which currently require cycle times of around 1 msec even at the highest transfer frequencies.

Even the event-controlled request of absolute values of the encoder by the controller via the serial interface is not readily suited to making adjustments of, say, highly dynamic servo drives. For example, either separate Hall sensors are employed to record the angular information of the rotor required for the permanent electronic commutation of electric motors, or incremental signals—A/B signals or sin/cos signals—of the encoder are used. For absolute angular and linear measuring systems in which the total absolute value is created in the encoder itself and transferred in series to the control these separate measures also require additional expenditure in terms of components, plugs and cables for electronic commutation.

### SUMMARY OF THE INVENTION

It is accordingly an object of the invention to provide a measuring system for processing angular and linear measured values that overcomes the above-mentioned disadvantages of the prior art devices of this general type, which provide the necessary conditions to carry out positional and adjustment processes required by a controller using only serial transfer of the absolute measured data. This relates to both the absolute angular/linear encoder that exchanges data with the controller directly via the serial interface and the indirect transfer of absolute measured values via a bus coupler in the bus system.

With the foregoing and other objects in view there is provided, in accordance with the invention, a measuring system. The measuring system contains a controller, an encoder for recording absolute measured values, a receiver unit not being part of the encoder and connected to the controller, and a bus system having a serial interface connected between the encoder and the receiver unit. The measured values are transferred from the encoder permanently through the serial interface to the receiver unit and is stored temporarily in the receiver and from the receiver unit the measured values are continuously transferred to the controller.

In accordance with an added feature of the invention, the receiver unit initiates a permanent transfer of the measured values from the encoder. Preferably, the controller initiates a permanent transfer of the measured values from the encoder through to the receiver unit.

In accordance with another feature of the invention, the receiver unit evaluates the measured values and transfers them as such to the controller. The receiver unit compares the measured values with pre-set values in the receiver unit and, if the measured values and the pre-set values are equivalent, the receiver unit informs the controller unit via signals. Preferably, the receiver unit is disposed directly at the controller.

In accordance with a further feature of the invention, the bus system has a bus coupler and the receiver unit is disposed directly at the bus coupler. Preferably, the bus coupler is integrated in the receiver unit and is connected to the encoder. Alternatively, the bus coupler with the receiver unit are disposed directly at the controller.

In accordance with an additional feature of the invention, the receiver unit is an integrated component. The receiver unit supplies the controller with the measured values at least one in series and parallel for output.

In accordance with another further feature of the invention, the encoder outputs total absolute values in binary form.

In accordance with a further added feature of the invention, the measuring system measures linear and angular measurements.

With the foregoing and other objects in view there is provided, in accordance with the invention, a method of operating a measuring system that serially outputs total absolute values processed in an encoder. The method includes feeding measured data permanently through a receiver unit disposed between the encoder and a controller, and transferring continuously the measured data to the controller.

Other features which are considered as characteristic for the invention are set forth in the appended claims.

Although the invention is illustrated and described herein as embodied in a measuring system for processing angular and linear measured values, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram showing absolute encoders, bus couplers and controllers that exchange data via serial interfaces and bus systems according to the invention;

FIG. 2 is a signal flow diagram of control commands as well as measured value transfers from the encoder in three examples of transfer modes (A, B, C); and

FIG. 3 is a diagram with absolute encoder measured values with pulse strings derived from threshold values for the electronic commutation of electric motors.

### DESCRIPTION OF THE PREFERRED EMBODIMENTS

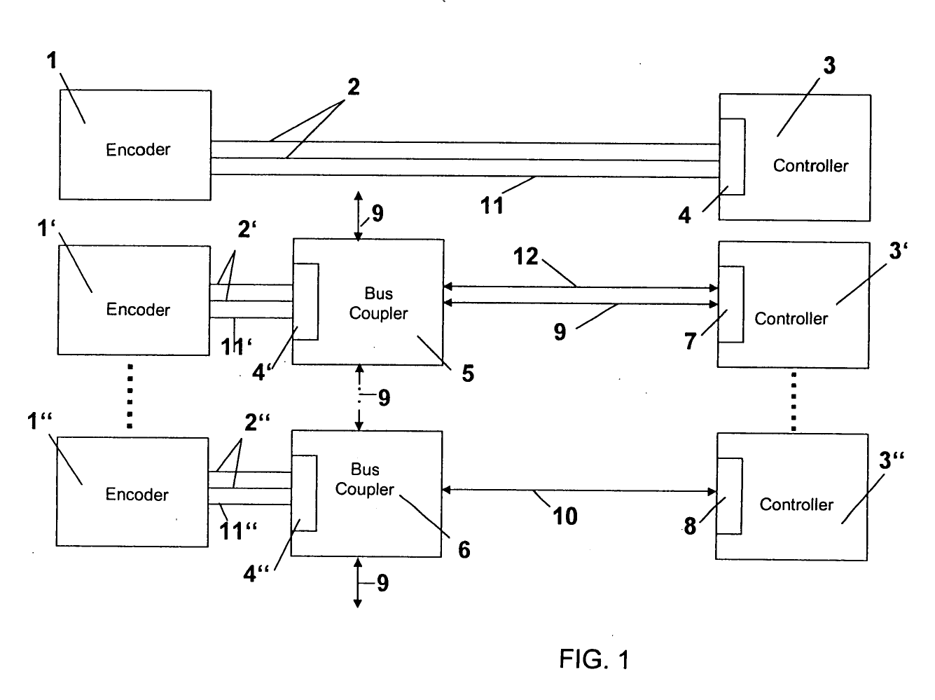

Referring now to the figures of the drawing in detail and first, particularly, to FIG. 1 thereof, there is shown a configuration of encoders 1, 1′, 1″ and controllers 3, 3′, 3″ which are actively connected in a number of ways via serial interfaces, including both a direct connection of encoder 1 to controller 3 via a serial interface 2 and the indirect connection of encoders 1′, 1″ to controllers 3′, 3″ via bus couplers 5, 6 together with serial interfaces 2′, 2″ and 9, 10. Between a serial data output 2, 2′, 2″ and the controller 3, 3′, 3″ in all these configurations there is always a receiver unit 4, 4′, 4″ for the measured data that is configured according to the invention. For bus systems there are, in addition to a receiver unit 4′, 4″ in the bus coupler, further receiver units 7, 8 configured to meet the requirements of the bus systems. All of the receiver units according to the invention are assigned the task of supplying the controller consistently with the most current measured data as fast as possible when such data is needed. This greatly reduces the pressure on the controller to make time-critical requests for measured data and leaves it virtually free to carry out controller functions.

The strain on the controller is particularly evident in regulating servo-motors with cycle times of around 50 . . . 100 μsec and the electronic commutation signals which are consistently required. The commutation alone requires recording of the angular absolute value relative to the rotation of around 1°, which for 6000 rpm=100 Hz demands measured value request and transfer within about 30 μsec. Up to now these requirements could only be met by employing additional measures i.e. output of additional incremental signals by the encoder and costly circuitry on the part of the control. Often other separate commutation encoders are incorporated, which record the absolute position by use of, for example, three Hall sensors located on the rotor circumference and which must be disposed according to the magnetic pole pitch of the electric motor.

Using the new absolute encoders, e.g. the angular and linear encoders described in the above-mentioned patent specifications, absolute values are recorded in around 20 nsec and transferred using around 10 MHz serial data transfer in real time i.e. with a clock frequency for the digital logic of about 50 MHz. Assuming a data length for absolute values of approximately 18 bit single-turn and approximately 18 bit multi-turn values, giving a combined total of approximately 36 bits, the absolute values may be transferred every 3.6 usec. The embodiment of the receiver unit according to the invention makes use of this possible rapid data transfer by continuously requesting measured data from the encoder. The receiver unit has the current measured values permanently on hand and can make them available to the controller as quickly as possible when required. For bus systems having relatively long command cycles in particular the benefits provided by such measured data that is uncoupled from and constantly requested by the controller and supplied by the receiver unit are evident. Updated measured values are thus available to each bus request within a few microseconds.

We do not intend to discuss here the wide variety of possibilities for existing bus systems in which transfer times of measured data to the controller may be shortened by making use of the measured data already present in the receiver unit of the bus coupler configured according to the invention. New conditions have been established, from the configuration of bus protocols to separate leads for bus cables for e.g. synchronization signals and real-time signals or data transfer, in order to make measured data available under real-time conditions. FIG. 1 shows a special lead 12 between the bus coupler 5 and the controller 3′ parallel to bus cable 9 which clarifies how existing bus systems can be modified for real-time capability in combination with the receiver unit 7. The illustration of the connection between the bus coupler 6 and the controller 3″ the design of a different bus lead or bus system 10 as compared to otherwise conventional bus connections 9 is intended to make it clear that real-time-capable measured data transfer takes place in cooperation with the receiver unit 8.

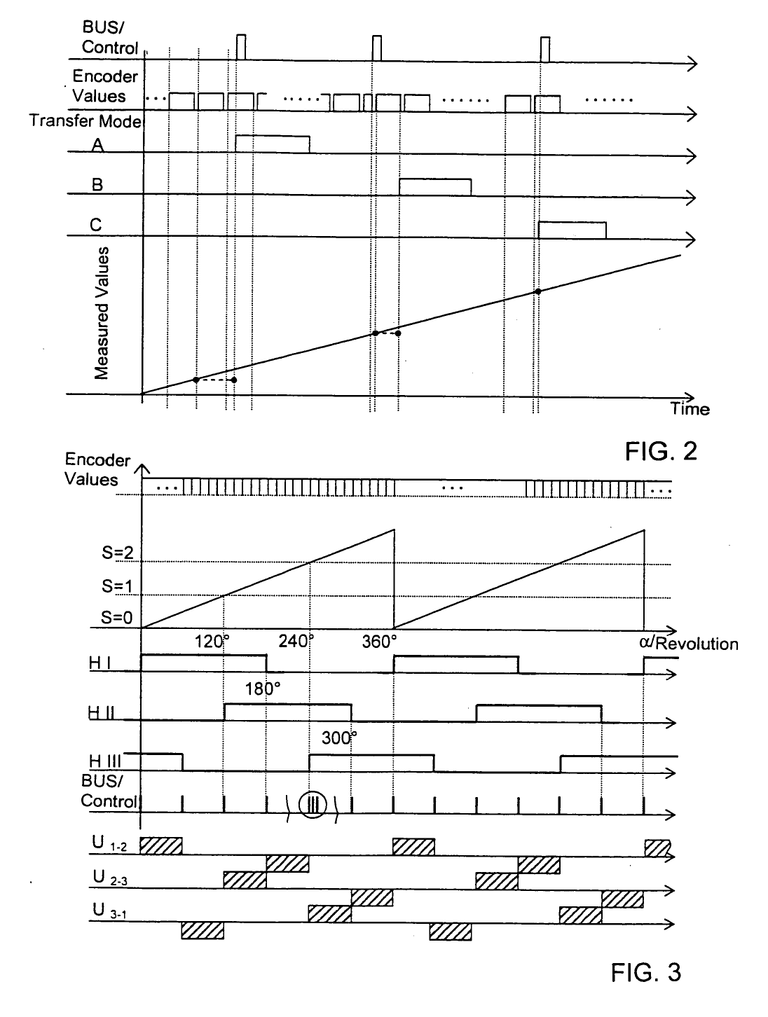

FIG. 2 provides a more detailed explanation of the advantages and configuration features of the receiver unit. Three examples of measured data transfers A, B, C by the receiver unit to the controller are shown, whereby it should be stated expressly that the possible embodiments are not limited to these examples. In addition, the graph shows an assumed measured value curve against time as well as measured value requests made by the controller directly or via the bus and the encoder signals permanently transferred in series to the receiver unit.

In the case of A the receiver unit has stored the previous measured value and not yet completely received the new measured value at the time of the request by the controller. In transfer mode A for transfer of measured values from the receiver unit to the controller the last complete measured value is supplied to the controller immediately on request and the deviation in measurement at this time is shown in the measured value graph.

In the case of B, the receiver unit has already stored one measured value and a new one is transferred. However, in mode B, the receiver unit has the job of recording the value present synchronously and at the same time as the controller makes the request and transferring it to the controller as quickly as possible. This clearly shows a transfer process described particularly in the above-mentioned patent specifications and carried out by an SSI interface with a measured value request via the pulse flank and the absolute encoders with around 20 nsec measured value processing.

In the case of C, the receiver unit carries out an evaluation of the transferred measured data by calculating the next measured value from the preceding changes. In the simplest case the very short measuring intervals of a few microseconds allow linear interpolation that has the advantage of increasing measured value resolution still further. Therefore, in C transfer mode the absolute values, which are very close to the actual measured value and have even greater resolution, can be transferred immediately to the controller. This shows particularly clearly how the permanently received measured values can be transferred by the receiver unit of the controller with better resolution and as rapidly as possible, i.e. virtually synchronously. Especially in situations where the receiver unit is disposed very close to the controller, the measured data can be supplied to the controller in parallel and hence benefit from guaranteed further processing with no delay. FIG. 1 shows the configuration via the receiver unit 4 and controller required to achieve these maximum measured value processing speeds. The use of the configuration of bus coupler 6 with the receiver unit 4″ is also beneficial for very fast measured value processing in those situations where the bus coupler 6 is disposed very close to the controller 3″ and the measured data can be transferred by the parallel bus 10. On the other hand, if bus coupler 5 must be located away from the controller 3′, an expansion 12 of the bus leads 9 is available to use the very fast recording of measured signals for at least one of the modes of the receiver unit described above.

A further requirement of the transfer of absolute measured data as in FIG. 3 clearly shows the benefits offered by further development of the receiver unit according to the invention. The drawing is self-explanatory and shows the situation of the electric motor to be commutated electronically within one revolution of the motor. The precise pulse strings H I, H II, H III must be derived permanently from the measured absolute values of the encoder at corresponding threshold values S=0, S=1, S=2, i.e. 0°, 120°, 240° during one revolution and transferred to the controller directly or via bus leads, in order to control motor windings U₁₋₂, U₂₋₃ and U₃₋₁ as shown. The receiver unit compares the received absolute measured values from the encoder with, for example, pre-set angular absolute values and consistently transfers the commutation commands to the controller. The command cycle time in the serial bus systems is currently too long and therefore requires additional wiring (FIG. 1, reference numeral 12) or special bus configurations (FIG. 1, reference numeral 10).

Using the receiver unit configured according to the invention, which may also be integrated into an ASIC if necessary, absolute measured data can be transferred from the encoder to the controller via serial interfaces as required for extremely demanding control operations. This allows efficient serial transfer of absolute measured data from the encoder to the controller by incorporating the receiver unit via an active network of electrical, optical or electromagnetic connections.

This application claims the priority, under 35 U.S.C. § 119, of German patent application No. 103 17 803.1, filed Apr. 16, 2003; the entire disclosure of the prior application is herewith incorporated by reference.

I claim:

1. A measuring system, comprising:
a controller;
an encoder for recording absolute measured values;
a receiver unit not being part of said encoder and connected to said controller; and
a bus system having a serial interface connected between said encoder and said receiver unit, the measured values being transferred from said encoder permanently through said serial interface to said receiver unit and being stored temporarily in said receiver and from said receiver unit the measured values are continuously transferred to said controller.

2. The measuring system according to claim 1, wherein said receiver unit initiates a permanent transfer of the measured values from said encoder.

3. The measuring system according to claim 1, wherein said controller initiates a permanent transfer of the measured values from said encoder through to said receiver unit.

4. The measuring system according to claim 1, wherein said receiver unit evaluates the measured values and transfers them as such to said controller.

5. The measuring system according to claim 1, wherein said receiver unit compares the measured values with pre-set values in said receiver unit and, if the measured values and the pre-set values are equivalent, said receiver unit informs said controller unit via signals.

6. The measuring system according to claim 1, wherein said receiver unit is disposed directly at said controller.

7. The measuring system according to claim 1, wherein said bus system has a bus coupler and said receiver unit is disposed directly at said bus coupler.

8. The measuring system according to claim 7, wherein said bus coupler is integrated in said receiver unit and is connected to said encoder.

9. The measuring system according to claim 7, wherein said bus coupler with said receiver unit are disposed directly at said controller.

10. The measuring system according to claim 1, wherein said receiver unit is an integrated component.

11. The measuring system according to claim 1, wherein said receiver unit supplies said controller with the measured values at least one in series and parallel for output.

12. The measuring system according to claim 1, wherein said encoder outputs total absolute values in binary form.

13. The measuring system according to claim 1, wherein the measuring system measures linear and angular measurements.

14. A method of operating a measuring system that serially outputs total absolute values processed in an encoder, which comprises the steps of:
feeding measured data permanently through a receiver unit disposed between the encoder and a controller; and
transferring continuously the measured data to the controller.

15. The method according to claim 14, wherein the measuring system is an angular and linear measuring system capable
